(19) United States
(12) Patent Application Publication
(10) Pub. No.: US 2013/0133205 A1
(43) Pub. Date: May 30, 2013

(54) ASSISTED OPENING FOLDING KNIFE WITH SLIDING KEY

(71) Applicant: Yen-Fen LO, Kaohsiung City (TW)

(72) Inventor: Yen-Fen LO, Kaohsiung City (TW)

(21) Appl. No.: 13/347,764

(22) Filed: Jan. 11, 2012

(30) Foreign Application Priority Data
Nov. 29, 2011 (TW) 100222541

(51) Int. Cl. B26B 1/04

(52) U.S. Cl. 30/160

(57) ABSTRACT

The present invention is to provide an assisted opening folding knife, which includes a handle, a blade pivotally connected to the handle, a sliding key, and a first resilient element having one end positioned in the handle and an opposite end pressing against an end of the blade. The sliding key is provided adjacent to a front end of the handle, and has a sliding portion exposed from the handle and a pressing portion opposite to the sliding portion. When the blade is received in the handle and the sliding portion is driven to move the sliding key and release the blade, the pressing portion presses the blade to rotate a predetermined angle for enabling the first resilient element to pop the blade out of the handle. Thus, a user only has to slide the sliding key to release and pop the blade out of the handle automatically.

### FIELD OF THE INVENTION

The present invention relates to a folding knife, more particularly to an assisted opening folding knife, which includes a handle and a blade pivotally connected to the handle. When the blade is received in the handle and the sliding key is moved, the blade will rotate a predetermined angle, and then be released and popped out of the handle automatically,

### BACKGROUND OF THE INVENTION

A conventional folding knife is typically composed of a handle and a blade, wherein the blade has one end pivotally connected to one end of the handle so that the blade can either be pivoted out of the handle for cutting or chopping purposes, or be pivoted into and received in the handle, thus allowing the blade to be carried around conveniently and safely. To use the folding knife, a user must hold the handle with one hand and pull the blade with the other, so as to rotate the blade out of the handle; in other words, the blade cannot be rotated out of the handle single-handedly. As such, not only is the operation of the folding knife troublesome, but also it is prohibitively difficult to rotate the blade out of the handle if the user is not allowed to operate the folding knife with both hands. For instance, if the user is in the middle of a climbing activity and has to hold on to a secure object with at least one hand in order to keep balance, then it will be very difficult for the user to rotate the blade out of the handle.

To overcome the aforesaid problem, U.S. Pat. No. 6,338,431 discloses a folding knife whose blade can be pushed out by a pressing action, as shown in FIG. 1. The folding knife 1 includes a handle 11, a blade 12, and a resilient element 13. The handle 11 has a front end pivotally connected to the blade 12, thus allowing the blade 12 to be received in the handle 11. The blade 12 has a protruding portion 121 which is on the edge side of the blade 12 and adjacent to the end of the blade 12 that is pivotally connected to the handle 11. The protruding portion 121 juts out from one side of the handle 11 when the blade 12 is completely received in the handle 11. The resilient element 13 has one end positioned adjacent to a rear end of the handle 11. The opposite end of the resilient element 13 extends to the blade 12 and is positioned thereon adjacent to where the handle 11 and the blade 12 are pivotally connected, When the blade 12 is completely received in the handle 11, the resilient element 13 generates a torque tending to rotate the blade 12 inward of the handle 11, thus keeping the blade 12 securely received in the handle 11. When a force is subsequently applied to the protruding portion 121 and thereby rotates the blade 12 out of the handle 11 to a predetermined angle, the resilient element 13 generates a torque tending to rotate the blade 12 outward of the handle 11, and the blade 12 is pushed out of the handle 11 by the resilient element 13 as a result.

In order for the user to rotate the blade 12 beyond the predetermined angle by pushing the protruding portion 121, the protruding portion 121 must be sufficiently large and high, which nevertheless imposes limitations on the structural design of the blade 12. Also, the protruding portion 121 could be so conspicuous that the overall appearance of the blade 12 is compromised. Moreover, as the position where the protruding portion 121 is exposed from the handle 11 corresponds to where the handle 11 is typically held, a user wishing to push out the blade 12 with a single hand must adjust his or her holding position significantly and grip the rear end of the handle 11 so as to make room for the thumb or index finger with which the protruding portion 121 is to be pressed. This, however, makes it difficult to hold the folding knife 1 firmly in the hand. Besides, while the user applies a force to the protruding portion 121 to drive the blade 12 out of the handle 11 against the force of the resilient element 13, the force applied by the user also acts on the front end of the handle 11. Because of that, the folding knife 1, which in single-handed operation can only be held insecurely at the rear end of the handle 11 as stated above, is likely to fall off the user's hand, thus causing inconvenience in use. Further, the blade 12 is fixed in the open position merely by the resilient force of the resilient element 13. Therefore, if subjected to an external force while in use, the blade 12 may easily rotate inward of the handle 11 and cut the user by accident, which is extremely unsafe.

In a nutshell, the conventional folding knives leave much room for improvement, particularly in terms of exterior design, convenience of operation, and safety in use. Hence, the issue to be addressed by the present invention is to design a folding knife that is both safe and easy to use.

### BRIEF SUMMARY OF THE INVENTION

In light of the shortcomings of the conventional folding knives, particularly those regarding exterior design, convenience of operation, and safety in use, the inventor of the present invention put years of practical experience into extensive research and experiment and finally succeeded in developing an assisted opening folding knife with a sliding key as disclosed herein.

The present invention provides an assisted opening folding knife with a sliding key, wherein the folding knife includes a handle, a blade, and a first resilient element in addition to the sliding key. The handle includes a first plate and a second plate. A front end of the handle is pivotally connected to the blade at a position adjacent to a first end of the blade. Thus, a second end of the blade can be rotated into the handle, allowing the blade to be received between the first plate and the second plate, or the second end of the blade can be rotated out of the handle. The first resilient element has one end positioned in the handle and an opposite end pressing against the first end of the blade. When the blade is completely received in the handle, the first resilient element cannot rotate the blade out of the handle. However, when an external force is applied to the blade such that the blade is rotated to a predetermined angle, the first resilient element causes the blade to pop out of the handle. The sliding key is provided adjacent to the front end of the handle. The side of the sliding key that is exposed from the handle is provided with a sliding portion. When slid, the sliding portion can drive the sliding key forward or backward relative to the handle. When the blade is received in the handle and the sliding key is pushed toward the front end of the handle, a front end of the sliding key locks the blade. When the blade has popped out of the handle and the sliding key is pushed toward the front end of the handle, the front end of the sliding key also serves to lock the blade. The side of the sliding key that is opposite the sliding portion is provided with a pressing portion. When the blade is in the received position and the sliding key is pushed toward a rear end of the handle, the sliding key is moved away from the position for locking the blade, and the pressing portion presses the blade beyond the predetermined angle. Therefore, a user only has to slide the sliding key, and the blade will automatically pop out of the handle; in other words, the convenience of use of the folding knife is substantially increased.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1 is a schematic view of a conventional folding knife;

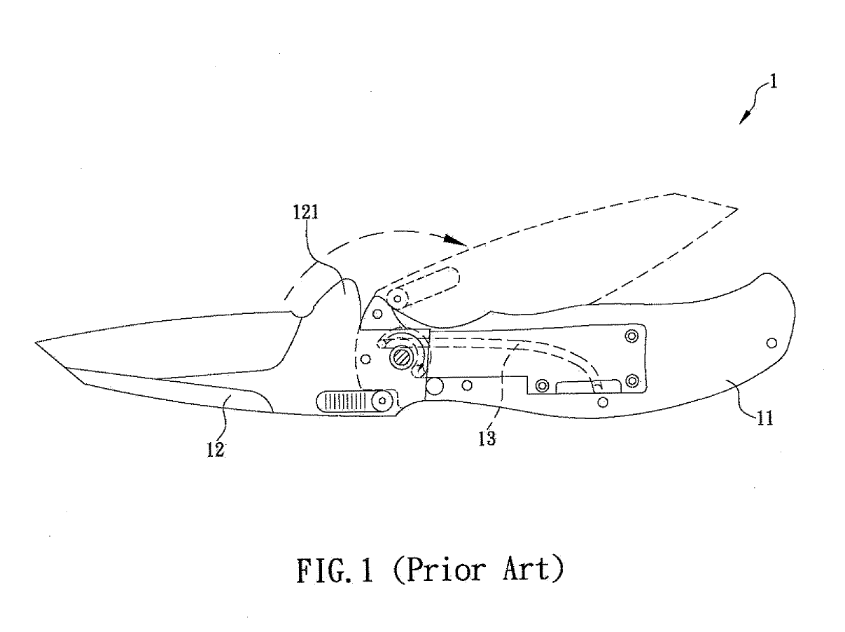

FIG. 2 is an exploded perspective view of the first preferred embodiment of the present invention;

FIG. 3 is a schematic view of the first preferred embodiment of the present invention, wherein the blade is in a received position;

FIG. 4 schematically shows the detent unit in the first preferred embodiment of the present invention;

FIG. 5 schematically shows how the sliding key in the first preferred embodiment of the present invention presses against the blade;

FIG. 6 is another schematic view of the first preferred embodiment of the present invention, wherein the blade is in an open position;

FIG. 7 is yet another schematic view of the first preferred embodiment of the present invention, wherein the sliding key is released from locking engagement;

FIG. 8 is a schematic view of the second preferred embodiment of the present invention, wherein the blade is in a received position;

FIG. 9 schematically shows how the sliding key in the second preferred embodiment of the present invention presses against the blade; and

FIG. 10 is another schematic view of the second preferred embodiment of the present invention, wherein the blade is in an open position.

### DETAILED DESCRIPTION OF THE INVENTION

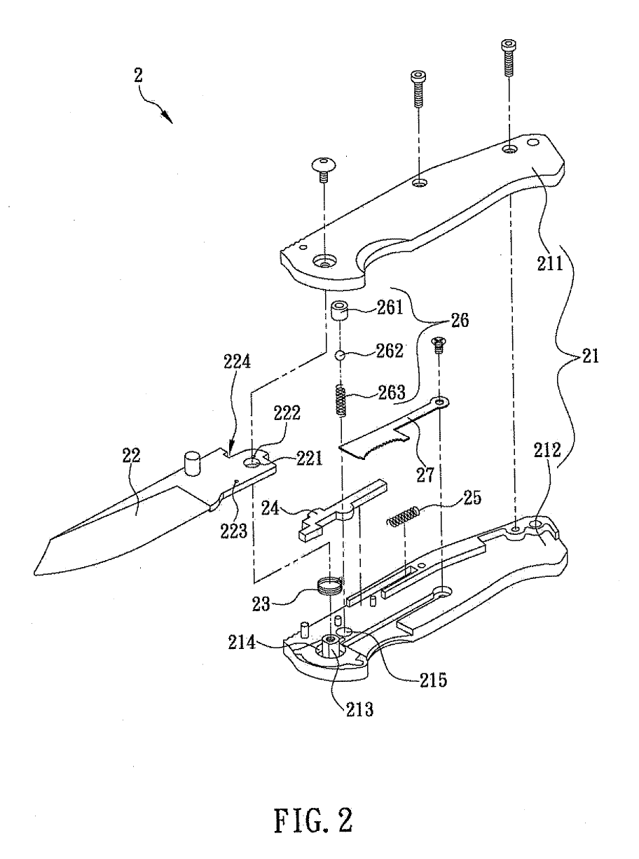

The present invention discloses an assisted opening folding knife with a sliding key. Referring to FIG. 2 for the first preferred embodiment of the present invention, the folding knife 2 includes a handle 21, a blade 22, a first resilient element 23, a sliding key 24, a second resilient element 25, a detent unit 26, and a resilient stopper 27. The handle 21 includes a first plate 211 and a second plate 212. The handle 21 is provided with a pivot pin 213, which is adjacent to a front end of the handle 21 and encircled by a first receiving groove 214. A second receiving groove 215 is formed adjacent to the first receiving groove 214. The blade 22 is formed with a pivot hole 221, which is adjacent to a first end of the blade 22. Immediately adjacent to the pivot hole 221 is an insertion hole 222. The blade 22 is pivotally connected to the front end of the handle 21 via the pivot hole 221 so that a second end of the blade 22 can be rotated to a position between the first plate 211 and the second plate 212, thus bringing the blade 22 to a received position in which the blade 22 is completely received in the handle 21. Alternatively, the blade 22 can be rotated completely out of the handle 21 and thus enters an open position. The blade 22 is provided with a detent hole 223 adjacent to the pivot hole 221. When the blade 22 is completely received in the handle 21, the detent hole 223 corresponds in position to the second receiving groove 215. The end of the blade 22 that is adjacent to the pivot hole 221 (e., the first end of the blade 22) is further provided with a positioning recess 224. The first resilient element 23 is a torsion spring and is received in the first receiving groove 214. The first resilient element 23 has one end positioned in the handle 21 and an opposite end extending into the insertion hole 222 and pressing against the blade 22 so as to pivot the blade 22 outward of the handle 21.

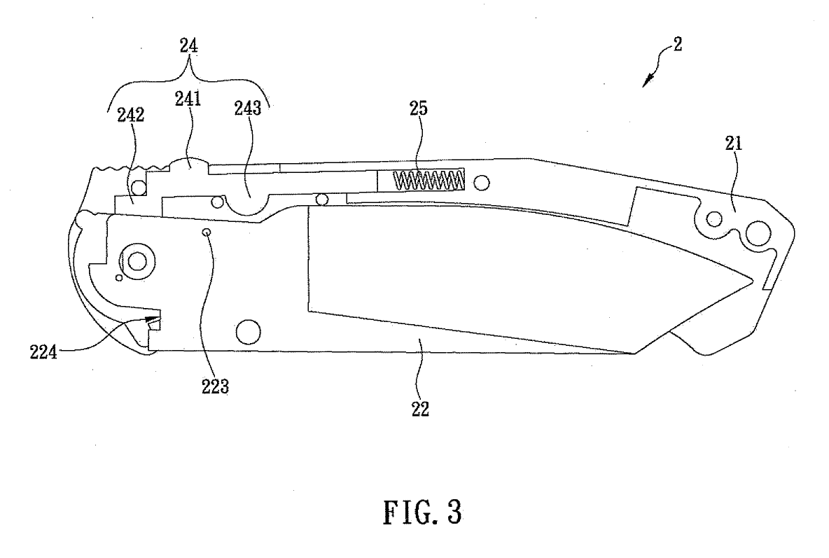

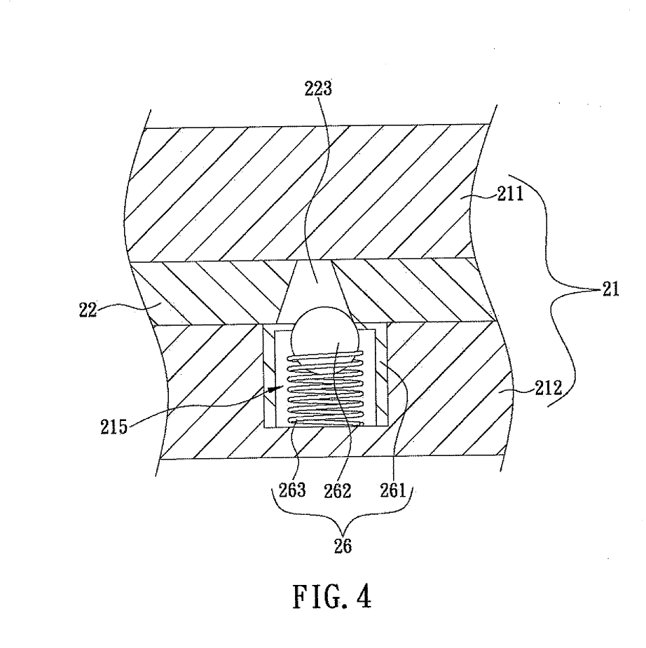

Referring to FIG. 3, the sliding key 24 is provided adjacent to the front end of the handle 21 and has one side which is exposed from the handle 21 and provided with a sliding portion 241. The sliding portion 241, when slid, can drive the sliding key 24 forward or backward in relation to the handle 21. The sliding key 24 has a front end protrudingly provided with a positioning projection 242, wherein the positioning projection 242 corresponds in configuration to the positioning recess 224. The side of the sliding key 24 that faces away from the sliding portion 241 is provided with a pressing portion 243. The second resilient element 25 has two ends which press against an inner portion of the handle 21 and a rear end of the sliding key 24 respectively, so as to push the sliding key 24 toward the front end of the handle 21. As shown in FIG. 4, the detent unit 26 is received in the second receiving groove 215 and consists of a sleeve 261, a steel ball detent 262, and a third resilient element 263, wherein the steel ball detent 262 and the third resilient element 263 are received in the sleeve 261. The two ends of the third resilient element 263 press against an inner portion of the handle 21 and a bottom portion of the steel ball detent 262 respectively, so as for a top portion of the steel ball detent 262 to partially jut out of a top surface of the sleeve 261. When the blade 22 is completely received in the handle 21, the detent hole 223 corresponds in position to the second receiving groove 215, and the hole wall of the detent hole 223 presses against the top portion of the steel ball detent 262; consequently, the blade 22 is held in place by the steel ball detent 262. The detent hole 223 in this embodiment is a conical through hole that tapers upward, and yet the structure of the detent hole 223 is not limited thereto. The detent hole 223 may also be designed as a cavity corresponding in configuration to the part of the top portion of the steel ball detent 262 that is to be exposed through the top surface of the sleeve 261. In practice, the detent hole 223 can be any cavity or hole with which the steel ball detent 262 can enter an interlocking relationship when the blade 22 is completely received in the handle 21. When it is desired to pivot the blade 22 relative to the handle 21, an external force sufficient to overcome the resilient force of the third resilient element 263 is required to push the steel ball detent 262 into the sleeve 261, thus allowing the blade 22 to pivot freely.

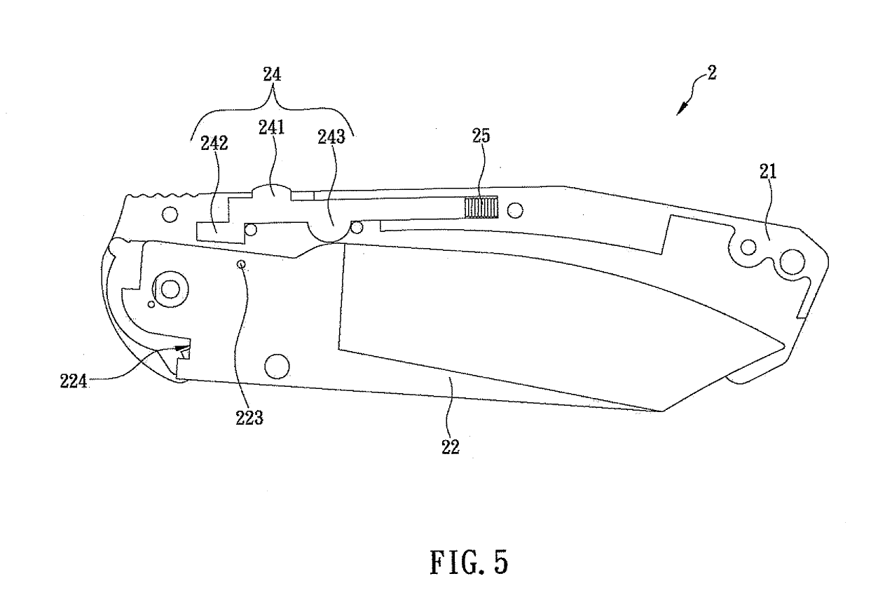

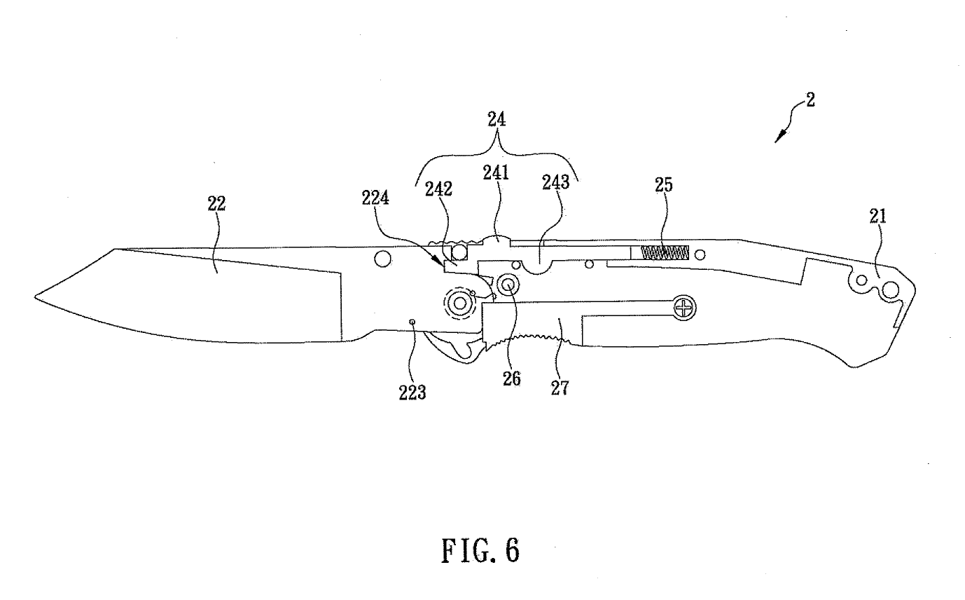

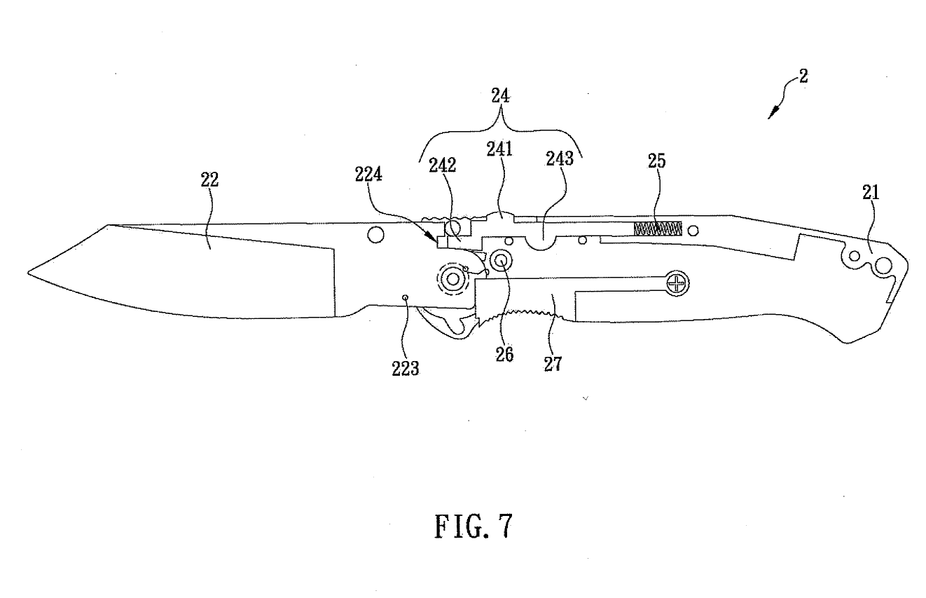

Referring again to FIG. 2, the resilient stopper 27 has one end fixedly provided in the handle 21 and a free end curved inward between the first plate 211 and the second plate 212. When the blade 22 has been rotated completely out of the handle 21, the free end of the resilient stopper 27 presses against the first end of the blade 22 (i.e., the end adjacent to which the blade 22 is pivotally connected to the handle 21). It is to be understood that the details described above serve only to illustrate the first preferred embodiment of the present invention and should not be construed as limitations imposed on the present invention. All changes readily conceivable by a person skilled in the art should fall within the scope of the present invention. A detailed description of how the folding knife 2 in the first preferred embodiment is operated and how its components interact with one another during operation is given below with reference to FIGS. 3 through 7. FIG. 3 schematically shows the blade 22 completely received in the handle 21. FIG. 5 schematically shows how the blade 22 is pushed by the pressing portion 243 so as to be rotated out of the handle 21. FIG. 6 schematically shows the blade 22 after it has been pushed completely out of the handle 21. FIG. 7 schematically shows how the sliding key 24 is moved toward the rear end of the handle 21 and released from locking engagement. FIG. 4 schematically shows the relationship between the detent unit 26, the handle 21, and the blade 22.

Referring to FIGS. 3 and 4, when the blade 22 is completely received in the handle 21, the detent hole 223 corresponds in position to the second receiving groove 215 such that the steel ball detent 262 partially juts out of the top surface of the sleeve 261. Although the first resilient element 23 (see FIG. 2) in this state applies a force to the blade 22 and thus generates a torque tending to rotate the blade 22 outward of the handle 21, the torque alone is not enough to overcome the resilient force of the third resilient element 263. Consequently, the hole wall of the detent hole 223 that is pressing against the top portion of the steel ball detent 262 fails to push the steel ball detent 262 into the sleeve 261, and the blade 22 is locked in the received position by the detent unit 26. Moreover, as the sliding key 24 has been pushed toward the front end of the handle 21, the pressing portion 243 is not pressing against the blade 22, but the positioning projection 242 is. This increases the stability of the blade 22's being locked in the received position and effectively reduces the force applied by the blade 22 to the steel ball detent 262. Reference is now made to FIGS. 4 and 5. A user can slide the sliding portion 241 from outside the handle 21 so that the sliding key 24 is moved toward the rear end of the handle 21 to release the positioning projection 242 from locking engagement with the blade 22. In the process, the steel ball detent 262 is subjected entirely to the force applied by the first resilient element 23 to the blade 22. As the user continues applying the sliding force to the sliding portion 241, the sliding key 24 overcomes the resilient force of the second resilient element 25 and is moved further toward the rear end of the handle 21. During this moving process, the pressing portion 243 presses against the blade 22, and the force applied by the user to the sliding key 24, and hence to the blade 22, overcomes the resilient force of the third resilient element 263. As a result, the hole wall of the detent hole 223 pushes the steel ball detent 262 into the sleeve 261, allowing the blade 22 to rotate out of the handle 21, and the detent hole 223 to move away from where the detent unit 26 is located (i.e., where the second receiving groove 215 lies). Now that the blade 22 is no longer locked by the detent unit 26, the torque generated by the first resilient element 23 (see FIG. 2) can rotate the blade 22 out of the handle 21 with success.

Referring to FIGS. 4 and 6, when the blade 22 is held in the open position and the sliding key 24 is pushed toward the front end of the handle 21, the positioning projection 242 of the sliding key 24 mates with, or is engaged in, the positioning recess 224 to lock the blade 22 even more firmly in the open position. In this embodiment, when the blade 22 has been rotated from the received position to the open position and the external force applied to the sliding key 24 is removed (i.e., the user stops applying the sliding force to the sliding portion 241), the sliding key 24 is moved toward the front end of the handle 21 by the pushing force of the second resilient element 25. Then, the sliding portion 241 is slid by the user to bring the positioning projection 242 into engagement in the positioning recess 224 and thereby lock the blade 22. Nevertheless, it is also feasible to increase the length of the second resilient element 25 so that, once the sliding key 24 is released, the positioning projection 242 is automatically driven into engagement in the positioning recess 224 by the pushing force of the second resilient element 25, thus locking the blade 22 in place. Alternatively, the second resilient element 25 can be dispensed with such that the sliding key 24 must be operated entirely by hand. Furthermore, in order to position the sliding key 24 securely at the front end of the handle 21, the sliding key 24 and the handle 21 can be additionally provided with a detent mechanism to enable engagement between the sliding key 24 and the handle 21. In practice, the details described above may vary as needed and are not limited to those disclosed in the foregoing embodiment. In the present embodiment, the free end of the resilient stopper 27 presses against the first end of the blade 22 (i.e., the end adjacent to which the blade 22 is pivotally connected to the handle 21) to further secure the blade 22 in the open position. Referring to FIG. 7, when it is desired to fold the blade 22 into the handle 21, the sliding key 24 must be slid toward the rear end of the handle 21 to disengage the positioning projection 242 from the positioning recess 24. Afterward, the resilient stopper 27 is pressed such that its free end is disengaged from the first end of the blade 22. Only then can the blade 22 be pivoted inward of the handle 21. Therefore, as long as the sliding key 24 is at the front end of the handle 21 and the positioning projection 242 is engaged with the positioning recess 224, the blade 22 is prevented from pivoting inward of the handle 21 even if the blade 22 is subjected to a relatively large force or if the user holding the handle 21 triggers the resilient stopper 27 by accident and thus disengages the resilient stopper 27 from the first end of the blade 22. As such, safety in use of the folding knife 2 is greatly increased. Moreover, as stated above, the user only has to slide the sliding key 24, and the blade 22 will readily pop out of the handle 21. Compared with the prior art, the convenience of operation is significantly improved. Not only that, when it is desired to fold the blade 22 into the handle 21, the locking engagement between the sliding key 24 and the blade 22 must be released first, or the blade 22 cannot be rotated inward of the handle 21. Thus, cut injuries by the blade 22 as may otherwise result from the blade 22 being pivoted inward of the handle 21 by an external force during operation of the folding knife 2 are effectively avoided to provide enhanced safety in use.

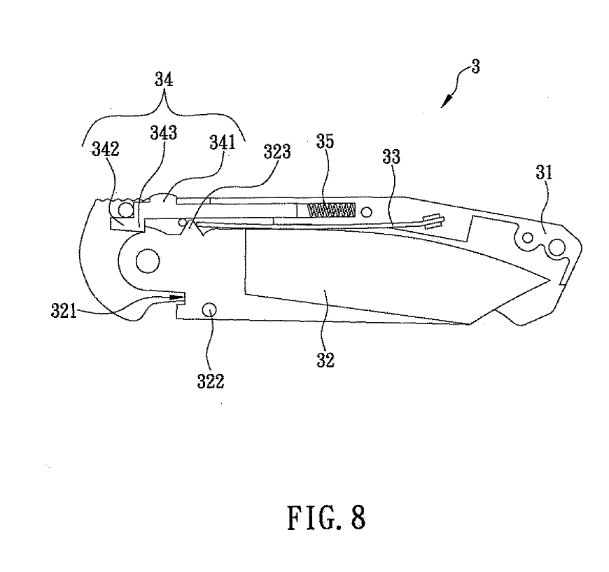

Please refer to FIG. 8 for the second preferred embodiments of the present invention. As shown in the drawing, the folding knife 3 includes a handle 31, a blade 32, a first resilient element 33, a sliding key 34, and a second resilient element 35. The blade 32 has a first end pivotally connected to a front end of the handle 31 so that a second end of the blade 32 can be rotated into or out of the handle 31. The first end of the blade 32 (i.e., the end of the blade 32 that is adjacent to its pivotally connecting position) is provided with a positioning recess 321. A post 322 is provided on one side of the blade 32 and is exposed from the handle 31 when the blade 32 is received in the handle 31. A protruding portion 323 is provided on another side of the blade 32 and adjacent to the pivotally connecting position of the blade 32. The first resilient element 33 has one end positioned in the handle 31. When the blade 32 is completely received in the handle 31, the opposite end of the first resilient element 33 presses against the protruding portion 323 such that the blade 32 is subjected to a torque tending to rotate the blade 32 inward of the handle 31; in consequence, the blade 32 is securely received in the handle 31. The sliding key 34 is provided adjacent to the front end of the handle 31. One side of the sliding key 34 is exposed from the handle 31 and provided with a sliding portion 341, wherein the sliding portion 341 can drive the sliding key 34 forward and backward in relation to the handle 31. A front end of the sliding key 34 is protrudingly provided with a positioning projection 342, wherein the positioning projection 342 matches the positioning recess 321. In addition, the side of the sliding key 34 that faces away from the sliding portion 341 is provided with a pressing portion 343. The second resilient element 35 has two ends pressing respectively against an inner portion of the handle 31 and a rear end of the sliding key 34 so as to push the sliding key 34 toward the front end of the handle 31.

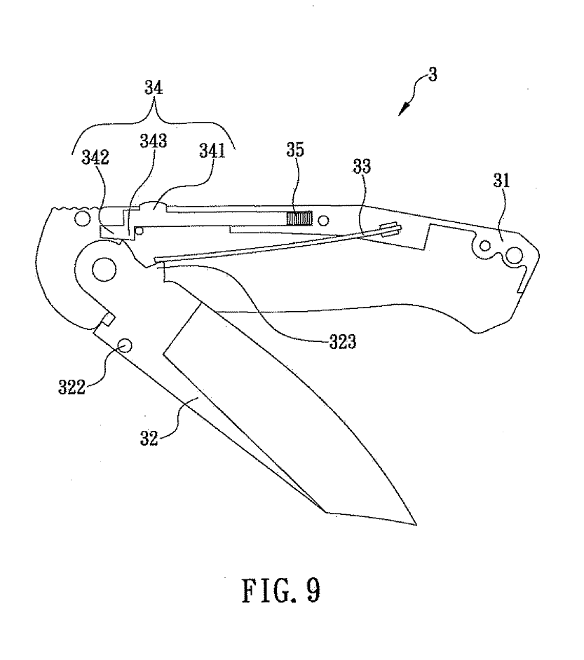

As shown in FIG. 9, a user can slide the sliding portion 341 from outside the handle 31 so that the sliding key 34 overcomes the resilient force of the second resilient element 35 and is moved toward a rear end of the handle 31. In the course where the sliding key 34 is moved toward the rear end of the handle 31, the pressing portion 343 presses against the blade 32. Meanwhile, the force applied by the user to the sliding key 34, and hence to the blade 32, causes the protruding portion 323 to press against the first resilient element 33 such that the first resilient element 33 is bent. In the second preferred embodiment, while the blade 32 is pivoted outward of the handle 31 from the received position, the first resilient element 33 is initially bent toward the sliding key 34 by the protruding portion 323. Once the blade 32 is rotated to a predetermined angle such that the tip of the protruding portion 323 is moved to the side of the first resilient element 33 that faces away from the sliding key 34, the first resilient element 33 releases all its accumulated elastic potential energy and pushes the protruding portion 323. As a result, the blade 32 is subjected to a torque tending to rotate the blade 32 outward of the handle 31 and is eventually pushed out of the handle 31. In addition, rotation of the blade 32 can be actuated by means of the post 322.

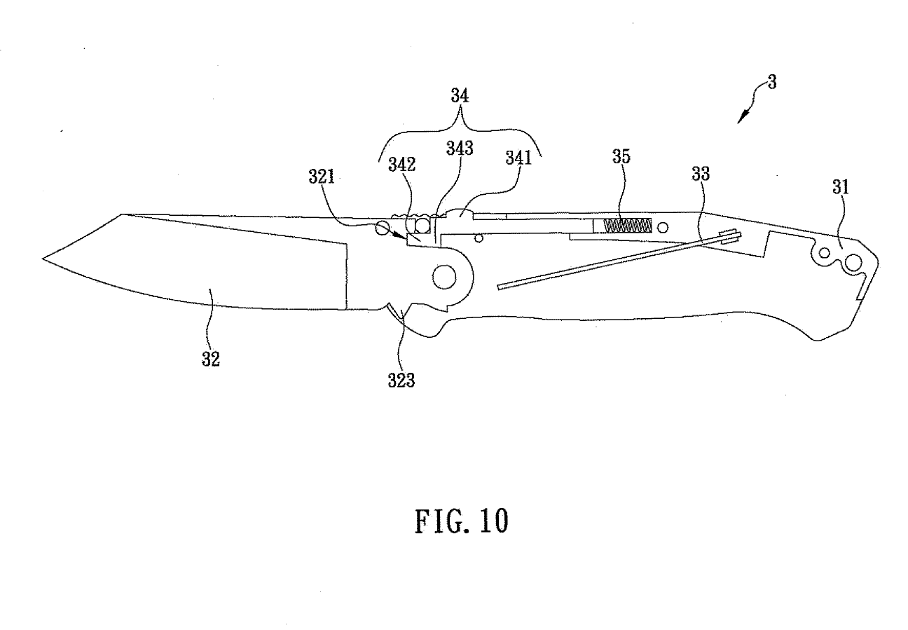

Referring to FIG. 10, the blade 32 has been pushed completely out of the handle 31 and thus enters the open position. As soon as the external force applied to the sliding key 34 is removed, the sliding key 34 is moved toward the front end of the handle 31 by the pushing force of the second resilient element 35, and the positioning projection 342 of the sliding key 34 is brought into engagement with the positioning recess 321 of the blade 32, thereby securing the blade 32 in the open position. The first resilient element 33 in this state is not under stress. When it is desired to fold the blade 32 into the handle 31, the sliding key 34 must be slid toward the rear end of the handle 31 to disengage the positioning projection 342 from the positioning recess 321; otherwise, the blade 32 cannot be pivoted inward of the handle 31. During the course in which the blade 32 is pivoted inward of the handle 31, the protruding portion 323 presses against and thereby bends the first resilient element 33. Once the blade 32 is rotated inward of the handle 31 beyond the predetermined angle, the tip of the protruding portion 323 is disengaged from the side of the first resilient element 33 that faces away from the sliding key 34. As a result, the first resilient element 33 releases all the elastic potential energy accumulated therein and pushes the protruding portion 323. The blade 32 is thus subjected to a torque tending to rotate it inward of the handle 31 and is securely received in the handle 31. According to the above description, a user only has to slide the sliding key 34, and the blade 32 will pop out of the handle 31, which provides enhanced convenience of use. Also, the engagement between the positioning projection 342 and the positioning recess 321 allows the blade 32 to be firmly held in the open position, thereby ensuring safety in use.

What is claimed is:

1. An assisted opening folding knife with a sliding key, comprising:
a handle comprising a first plate and a second plate;
a blade having a first end adjacent to which the blade is pivotally connected to a front end of the handle so that a second end of the blade is rotatable either into the handle, thus allowing the blade to be received between the first plate and the second plate, or out of the handle;
a first resilient element having a first end positioned in the handle and a second end pressing against the first end of the blade so that, once the blade is rotated out of the handle to a predetermined angle, the first resilient element causes the blade to pop out of the handle; and
the sliding key provided adjacent to the front end of the handle and movable forward and backward relative to the handle, wherein when the blade is received in the handle and the sliding key is pushed toward the front end of the handle, a front end of the sliding key presses against and locks the blade, and when the blade has popped out of the handle and the sliding key is pushed toward the front end of the handle, the front end of the sliding key also presses against and locks the blade, the sliding key having a side which is exposed from the handle and is provided with a sliding portion, the sliding key having another side which faces away from the sliding portion and is provided a pressing portion, wherein when the blade is received in the handle and the sliding key is pushed toward a rear end of the handle, the sliding key is moved away from a position where the sliding key locks the blade, and the pressing portion presses the blade beyond the predetermined angle.

2. The assisted opening folding knife of claim I, further comprising a second resilient element, the second resilient element having two ends pressing respectively against an inner portion of the handle and a rear end of the sliding key.

3. The assisted opening folding knife of claim 2, wherein the front end of the sliding key is protrudingly provided with a positioning projection, the positioning projection being configured for locking the blade and thus holding the blade in a received position when the blade is received in the handle and the sliding key is pushed toward the front end of the handle, and wherein the first end of the blade is provided with a positioning recess adjacent to a pivotally connecting position of the blade and the handle, the positioning recess corresponding in configuration to the positioning projection so that, when the blade has popped out of the handle and the sliding key is pushed toward the front end of the handle, the positioning projection is engaged in the positioning recess to lock the blade and thus hold the blade in an open position.

4. The assisted opening folding knife of claim 3, wherein the blade is further provided with a detent hole, and the handle is provided therein with a detent unit, the detent hole corresponding in position to the detent unit when the blade is completely received in the handle, the detent hole being away from the detent unit when the blade has been rotated out of the handle to the predetermined angle.

5. The assisted opening folding knife of claim 4, wherein the detent unit comprises:
a sleeve;
a steel ball detent received in the sleeve; and
a third resilient element received in the sleeve and having two ends pressing respectively against the handle and the steel ball detent so that a portion of the steel ball detent can jut out of a top surface of the sleeve.

6. The assisted opening folding knife of claim 3, wherein the first end of the blade is further provided with a protruding portion so that, when the blade is completely received in the handle, the second end of the first resilient element presses against and applies a force to the protruding portion and generates a torque tending to rotate the blade inward of the handle, and when the blade has been rotated out of the handle to the predetermined angle, the first resilient element generates a torque tending to rotate the blade outward of the handle.

7. The assisted opening folding knife of claim 5, wherein the blade is further provided with at least a post, the at least a post being exposed from the handle when the blade is completely received in the handle.

8. The assisted opening folding knife of claim 6, wherein the blade is further provided with at least a post, the at least a post being exposed from the handle when the blade is completely received in the handle.

9. The assisted opening folding knife of claim 7, further comprising a resilient stopper, the resilient stopper having an end fixedly provided in the handle and a free end curved inward between the first plate and the second plate, wherein when the blade has been rotated completely out of the handle, the free end of the resilient stopper presses against the first end of the blade.

10. The assisted opening folding knife of claim 8, further comprising a resilient stopper, the resilient stopper having an end fixedly provided in the handle and a free end curved inward between the first plate and the second plate, wherein when the blade has been rotated completely out of the handle, the free end of the resilient stopper presses against the first end of the blade.
